(19) United States
(12) Patent Application Publication
(10) Pub. No.: US 2012/0264581 A1
(43) Pub. Date: Oct. 18, 2012

(54) System and Method for Forming a Multiple Wall Container

(76) Inventors: Vladislav Babinsky, Fuquay Varina, NC (US); Sven Samuel Arenander, Richmond, VA (US)

(21) Appl. No.: 13/085,066

(22) Filed: Apr. 12, 2011

(51) Int. Cl. B31C 7/02; B31B 17/00; B31B 49/02; B31C 11/04

(52) U.S. Cl. 493/112; 493/128; 493/152; 493/160

(57) ABSTRACT

A method for forming a multiple wall container include the steps of (1) providing a base container and an overwrap, the base container defining a longitudinal axis, (2) applying an adhesive to the overwrap, (3) rotating the base container about the longitudinal axis and (4) applying the adhesive-coated overwrap to the base container while the base container is rotating.

### FIELD

This application relates to containers having a multiple wall structure, such as a double wall structure, and, more particularly, to multiple wall beverage cups, such as double wall beverage cups.

### BACKGROUND

Beverage containers, such as beverage cups, are used to hold various hot and cold beverages. Unfortunately, beverage containers having weak walls may be damaged or even crushed when grasped by a user. The potential for such damage presents the risk of unintentionally spilling the contents of the container, which may result in an unpleasant mess or, in the case of hot beverages, physical injury. Therefore, manufacturers attempt to impart sufficient rigidity to beverage cups such that the cups may be grasped by a user without spilling the contents of the cup.

Furthermore, beverage containers having insulative properties are also desired. For example, a beverage cup having an insulated side wall may minimize heat transfer between the contents of the cup and the ambient air, thereby keeping hot beverages hot and cold beverages cold.

Beverage cups having a double wall structure are known to have increased structural rigidity and to provide improved insulation. Currently, certain double wall beverage cups are manufactured using an overwrapping machine, such as the PMC OW 800 overwrapping machine available from Paper Machinery Corporation of Milwaukee, Wis. A typical overwrapping machine includes a stationary mandrel and a wrapping assembly. A base cup is mounted on the stationary mandrel such that the wrapping assembly may wrap an overwrap, such as a paperboard overwrap, onto the stationary base cup, thereby forming the second wall of the double wall beverage cup.

Unfortunately, use of an overwrapping machine to form double wall beverage cups significantly limits production speed. For example, the PMC OW 800 overwrapping machine is capable of producing at most about 165 cups per minute.

Accordingly, those skilled in the art continue with research and development efforts in the field of multiple wall containers.

### SUMMARY

In one aspect, disclosed is a method for forming a multiple wall container. The method may include the steps of (1) providing a base container and an overwrap, the base container defining a longitudinal axis, (2) applying an adhesive to the overwrap, (3) rotating the base container about the longitudinal axis and (4) applying the adhesive-coated overwrap to the base container while the base container is rotating.

In another aspect, the disclosed method for forming a multiple wall container may include the steps of (1) providing a base container that defines a longitudinal axis and includes a side wall and a base wall, wherein the side wall circumferentially extends about the longitudinal axis, (2) providing an overwrap comprising paperboard, (3) applying an adhesive to the overwrap, (4) rotating the base container about the longitudinal axis and (5) applying the overwrap to the side wall of the base container while the base container is rotating such that the adhesive is positioned between the side wall and the overwrap.

In another aspect, disclosed is a system for applying an overwrap to a base container to form a multiple wall container. The system may include a carousel assembly configured to rotate about a first axis of rotation, the carousel assembly supporting the base container and rotating the base container about a longitudinal axis of the base container, and a vacuum transfer drum configured to rotate about a second axis of rotation, the vacuum transfer drum supporting the overwrap, wherein the vacuum transfer drum is positioned proximate the carousel assembly such that the vacuum transfer drum transfers the overwrap to the base container as the base container is rotated by the carousel assembly.

In yet another aspect, disclosed is a system for applying an overwrap to a base container to form a multiple wall container. The system may include a carousel assembly configured to rotate about a first axis of rotation, the carousel assembly supporting the base container and rotating the base container about a longitudinal axis of the base container, and a vacuum transfer drum configured to rotate about a second axis of rotation, the vacuum transfer drum supporting the overwrap, the overwrap being at least partially coated with an adhesive, wherein the vacuum transfer drum is positioned proximate the carousel assembly such that the vacuum transfer drum transfers the adhesive-coated overwrap to the base container as the base container is rotated by the carousel assembly.

Other aspects of the disclosed system and method for forming a multiple wall container will become apparent from the following description, the accompanying drawings and the appended claims.

### BRIEF DESCRIPTION OF THE DRAWINGS

FIG. 1 is a front elevational view, in section, of one aspect of the disclosed multiple wall container;

FIG. 2 is a cross-sectional view of a portion of the multiple wall container of FIG. 1;

FIG. 3 is a front elevational view of the base cup of the multiple wall container of FIG. 1;

FIG. 4 is a top plan view of the overwrap of the multiple wall container of FIG. 1, shown with an adhesive applied thereto;

FIG. 5 is a flow chart showing several steps of a method for forming the disclosed multiple wall container; and

FIG. 6 is a schematic top plan view of a system for forming the disclosed multiple wall container.

### DETAILED DESCRIPTION

It has now been discovered that multiple wall containers may be formed at a significantly higher production speed using a machine similar to a labeling machine, such as the labeling machine disclosed in U.S. Pat. No. 4,416,714 to Hoffmann. Specifically, it has now been discovered that a multiple wall container may be formed by adhering an overwrap, such as a paperboard overwrap, to a base container using a carousel-type machine that rotates the base container about a longitudinal axis as the overwrap is being applied to the base container.

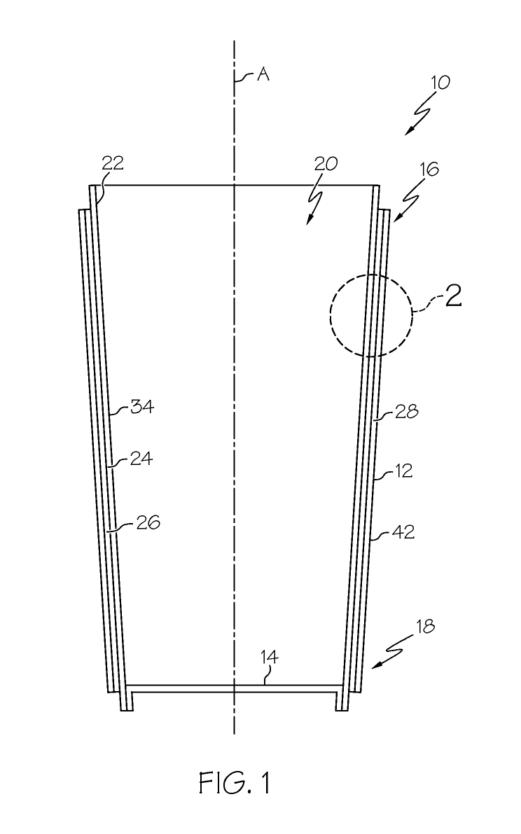

Referring to FIG. 1, one aspect of the disclosed multiple wall container, generally designated 10, may be formed as a double wall beverage cup. While the multiple wall container 10 is shown in FIG. 1 as a beverage cup having a generally frustoconical shape, those skilled in the art will appreciate that containers of various shapes and sizes may be constructed without departing from the scope of the present disclosure.

The multiple wall container 10 may include a side wall 12 and a base wall 14. The side wall 12 may include an upper end portion 16 and a lower end portion 18, and may extend circumferentially about a longitudinal axis A to define an internal volume 20 of the multiple wall container 10. The base wall 14 may be connected to the lower end portion 18 of the side wall 12 to partially enclose the internal volume 20. The upper end portion 16 of the side wall 12 may define an opening 22 into the internal volume 20.

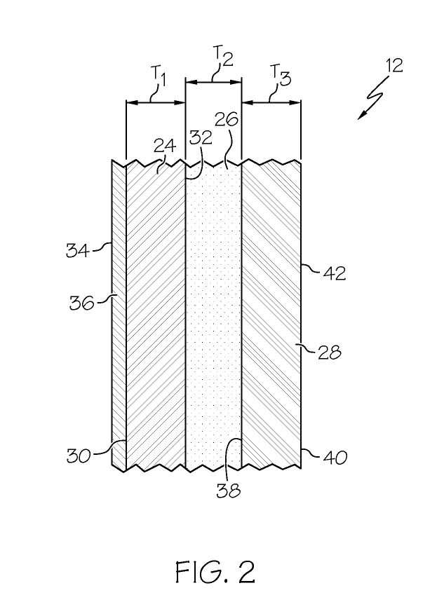

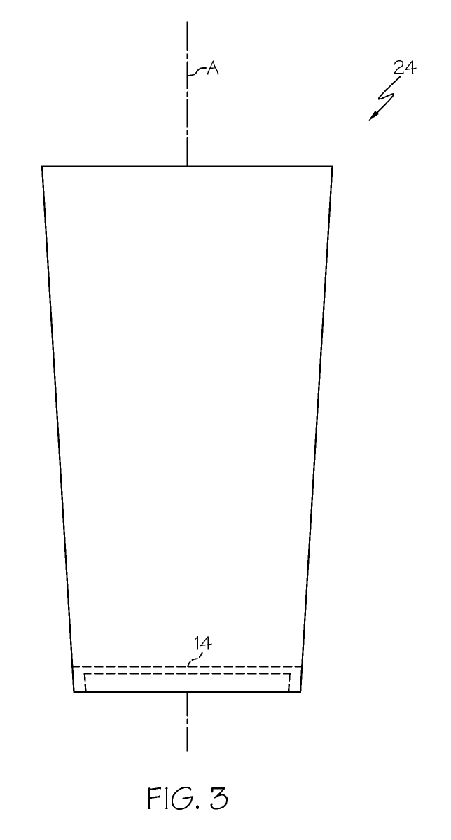

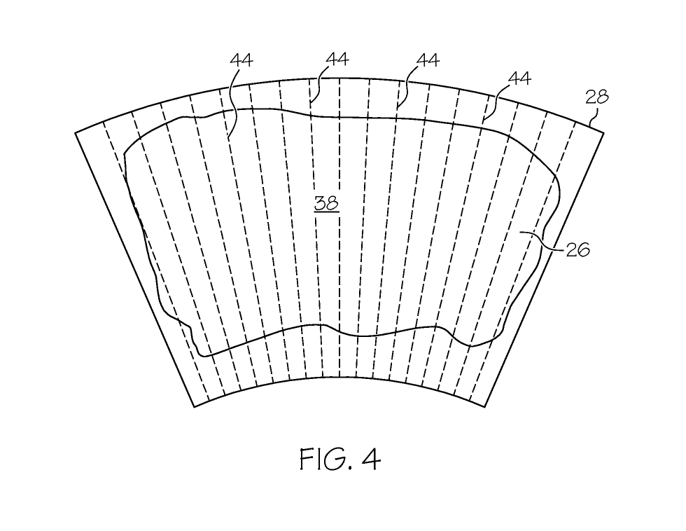

The side wall 12 of the multiple wall container 10 may be formed by applying an overwrap 28 (FIG. 4) to a base cup 24 (FIG. 3), such as with an adhesive 26 (FIG. 2). Therefore, as shown in FIG. 2, the side wall 12 may be formed as a layered structure that includes a base cup layer 24, an adhesive layer 26 and an overwrap layer 28. The adhesive layer 26 may be positioned between the base cup layer 24 and the overwrap layer 28. Additional layers, such as additional adhesive layers and additional overwrap layers, may be included without departing from the scope of the present disclosure.

Referring to FIG. 2, the base cup 24 may include an inner surface 30 and an outer surface 32, and may have a cross-sectional thickness T₁. The inner surface 30 of the base cup 24 may define (or may be proximate) the interior surface 34 of the side wall 12.

Optionally, the inner surface 30 of the base cup 24 may be coated with a moisture barrier layer 36, thereby rendering the interior surface 34 of the side wall 12 resistant to moisture penetration when the internal volume 20 of the multiple wall container 10 is filled with a beverage (not shown). The moisture barrier layer 36 may have a cross-sectional thickness ranging from about 0.5 to about 3.5 points, wherein 1 point equals 0.001 inches. For example, the moisture barrier layer 36 may be (or may include) a layer of polyethylene that has been laminated, extrusion coated or otherwise connected (e.g., with adhesives) to the inner surface 30 of the base cup 24. Other moisture barrier materials useful in forming the moisture barrier layer 36 are commercially available and known to the skilled artisan.

In a first expression, the base cup 24 may be formed by shaping a blank on a cup forming machine. In a first implementation of the first expression, the base cup 24 may be formed by shaping a paperboard blank on a cup forming machine, such as the PMC 1002 cup/container machine available from Paper Machinery Corporation. The paperboard blank may have a cross-sectional thickness T₁ of at least about 6 points, such as about 8 to about 24 points, wherein 1 point equals 0.001 inch. In a second implementation of the first expression, the base cup 24 may be formed by shaping a polymeric blank on a cup forming machine, such as the PMC 1002P container machine available from Paper Machinery Corporation. The polymeric blank may be formed from a polymeric material, such as polycarbonate or polyethylene terephthalate.

In other expressions, the base cup 24 may be formed by vacuum molding, extrusion molding, injection molding, thermoforming or the like.

At this point, those skilled in the art will appreciate that the base cup 24 may be formed from various materials using various techniques, and may be configured in various shapes and sizes, without departing from the scope of the present disclosure.

The adhesive 26 may be any adhesive capable of connecting the overwrap 28 to the base cup 24. For example, the adhesive 26 may be a water-based adhesive, such as a latex adhesive, or an organic solvent-based adhesive.

The adhesive 26 may be positioned between the base cup 24 and the overwrap 28, and may have a cross-sectional thickness T₂. The cross-sectional thickness T₂ of the adhesive layer 26 may range from about 20 to about 200 percent of the cross-sectional thickness T₃ of the overwrap 28. For example, the cross-sectional thickness T₂ of the adhesive layer 26 may be at least about 4 points, such as about 6 to about 12 points or about 10 to about 20 points.

In one expression, the adhesive 26 may be formulated as a foam. The foam adhesive may be formed by mechanically whipping the components of the adhesive 26 prior to application. As an example, 10 to 60 percent of the foam adhesive 26 may be open voids. Optionally, a foam forming agent may be included in the adhesive formulation to promote foam formation.

In another expression, the adhesive 26 may have a pseudoplasticity index in the range of 0.3 to 0.5 or, more particularly, in the range of 0.40 to 0.45. Such a pseudoplasticity index may provide the adhesive layer 26 with a sufficient minimum cross-sectional thickness T₂, while preserving the ability to apply the adhesive at a low viscosity. For example, the adhesive may have a low shear viscosity in the range of 20,000 to 50,000 centipoises and a high shear viscosity in the range of 100 to 5,000 centipoises.

In yet another expression, the adhesive 26 may be a thermally insulating adhesive. An adhesive may be deemed thermally insulating if it has a thermal conductivity that is less than the thermal conductivity of the base cup 24. For example, the ratio of the thermal conductivity of the adhesive 26 to the thermal conductivity of the base cup 24 may be at least about 1:1.25, such as 1:1.5, 1:2 or even 1:3.

A suitable thermally insulating adhesive 26 may be formed as a composite material that includes an organic binder and a filler. The organic binder may comprise 15 to 70 percent by weight of the adhesive 26 and the filler may comprise 2 to 70 percent by weight of the adhesive 26.

The organic binder component of the thermally insulating adhesive 26 may be any material, mixture or dispersion capable of bonding the overwrap 28 to the base cup 24. The organic binder may also have insulating properties. Examples of suitable organic binders include latexes, such as styrene-butadiene latex and acrylic latex, starch, such as ungelatinized starch, polyvinyl alcohol, polyvinyl acetate, and mixtures and combinations thereof.

The filler component of the thermally insulating adhesive 26 may include an organic filler, an inorganic filler or a combination of organic and inorganic fillers. Organic fillers include hard organic fillers and soft organic fillers. Examples of suitable hard organic fillers include sawdust and ground wood. Examples of suitable soft organic fillers include cellulose pulp, pearl starch, synthetic fiber (e.g., rayon fiber), gluten feed, corn seed skin and kenaf core (a plant material). Examples of suitable inorganic fillers include calcium carbonate, clay, perlite, ceramic particles, gypsum and plaster. For example, organic filler may comprise 2 to 70 percent by weight of the thermally insulating adhesive 26 and inorganic filler may comprise 0 to 30 percent by weight of the thermally insulating adhesive 26.

All or a portion of the filler may have a relatively high particle size (e.g., 500 microns or more). The use of high particle size filler material may provide the thermally insulating adhesive 26 with structure such that the thermally insulating adhesive 26 functions to further space the overwrap 28 from the base cup 24. For example, the thermally insulating adhesive 26 may be formed as a composite material that includes an organic binder and a hard organic filler, such as sawdust, that has an average particle size of at least 500 microns, such as about 1000 to about 2000 microns.

As one option, the thermally insulating adhesive 26 may additionally include a plasticizer. The plasticizer may comprise 0.5 to 10 percent by weight of the thermally insulating adhesive 26. Examples of suitable plasticizers include sorbitol, Emtal emulsified fatty acids and glycerine.

As another option, the thermally insulating adhesive 26 may additionally include sodium silicate, which may act as a filler, but is believed to aid in binding and curing of the binder by rapidly increasing viscosity of the binder during the drying process. The sodium silicate may comprise 0 to 15 percent by weight of the thermally insulating adhesive 26, such as about 1 to about 5 percent by weight of the thermally insulating adhesive 26.

As yet another option, the thermally insulating adhesive 26 may be formulated to be biodegradable.

As a specific example, the thermally insulating adhesive 26 may include styrene-butadiene or acrylic SRB latex (binder), wood flour (organic filler), AeroWhip® (foam stabilizer available from Ashland Aqualon Functional Ingredients of Wilmington, Del.), corn fibers (organic filler), calcium carbonate (inorganic filler) and starch (binder), wherein the components of the thermally insulating adhesive have been mechanically whipped together to form a foam. Other examples of suitable thermally insulating adhesives are described in greater detail in U.S. Ser. No. 61/287,990 filed on Dec. 18, 2009, the entire contents of which are incorporated herein by reference.

At this point, those skilled in the art will appreciate that various adhesives 26 may be suitable for connecting the overwrap 28 to the base cup 24, and that use of compositions having adhesive properties as well as one or more additional functionalities will not result in a departure from the scope of the present disclosure.

The overwrap 28 may include an inner surface 38 and an outer surface 40, and may have a cross-sectional thickness T₃. The outer surface 40 of the overwrap 28 may define (or may be proximate) the exterior surface 42 of the side wall 12.

As shown in FIG. 1, the overwrap 28 may have an overall surface area that is less than the overall surface area of the base cup 24. Therefore, the overwrap 28 may cover only a portion of the outer surface 32 of the base cup 24. As one example, the overwrap 28 may cover at least 60 percent of the base cup 24. As another example, the overwrap 28 may cover at least 80 percent of the base wall 24. As yet another example, the overwrap 28 may cover at least 90 percent of the base wall 24.

In one construction, the overwrap 28 may be formed by die-cutting a sheet of paperboard to produce an overwrap blank, as shown in FIG. 4. The paperboard forming the overwrap 28 may be bleached or unbleached, and may have a basis weight of at least about 85 pounds per 3000 square feet and a cross-sectional thickness T₃ of at least about 6 points. For example, the overwrap 28 may be formed from paperboard, such as linerboard or solid bleached sulfate (SBS), having a basis weight ranging from about 180 to about 270 pounds per 3000 square feet and a thickness T₃ ranging from about 8 to 36 points.

Optionally, the paperboard used to form the overwrap 28 may include various components and optional additives in addition to cellulosic fibers. For example, the overwrap 28 may optionally include one or more of the following: binders, fillers (e.g., ground wood particles), organic pigments, inorganic pigments, hollow plastic pigments, expandable microspheres and bulking agents, such as chemical bulking agents.

In one specific realization, the paperboard used to form the overwrap 28 may be manufactured to have a reduced stiffness and/or may undergo a post-manufacture process to reduce stiffness. Without being limited to any particular theory, it is believed that use of paperboard with a reduced stiffness may facilitate wrapping of the overwrap 28 about the base cup 24, and may inhibit (if not eliminate) the spring back of the overwrap 28 after the overwrap has been applied to the base cup 24.

As one example, the paperboard used to form the overwrap 28 may have a Taber 15° stiffness (TAPPI T-489) of at most 100 gcm in the cross direction. As another example, the paperboard used to form the overwrap 28 may have a Taber 15° stiffness (TAPPI T-489) of at most 80 gcm in the cross direction. As another example, the paperboard used to form the overwrap 28 may have a Taber 15° stiffness (TAPPI T-489) of at most 60 gcm in the cross direction. As another example, the paperboard used to form the overwrap 28 may have a Taber 15° stiffness (TAPPI T-489) of at most 40 gcm in the cross direction. As yet another example, the paperboard used to form the overwrap 28 may have a Taber 15° stiffness (TAPPI T-489) of at most 20 gcm in the cross direction.

Various techniques or combinations of techniques may be used to reduce the stiffness of the paperboard that forms the overwrap 28. While several techniques are disclosed below, other techniques will become apparent to those skilled in the art upon reading the present disclosure.

A first technique for reducing the stiffness of the overwrap 28 may include using thinner paperboard when forming the overwrap 28. For example, paperboard having a cross-sectional thickness T₃ ranging from about 6 to about 10 points may yield an overwrap 28 having the desired stiffness.

A second technique for reducing the stiffness of the overwrap 28 may include forming a paperboard having a reduced stiffness. As one example, the pulp used to form the paperboard may undergo less (or no) refining such that the resulting paperboard is inherently less stiff. As another example, a debonding agent, such as a PROSOFT™ debonding agent available from Ashland, Inc. of Dublin, Ohio, may be introduced to the pulp to render the resulting paperboard less stiff.

A third technique for reducing the stiffness of the overwrap 28 may include mechanically weakening the paperboard used to form the overwrap 28. For example, a plurality of longitudinal score lines 44 may be formed in the paperboard, as shown in FIG. 4. Alternatively, the longitudinal lines 44 may be formed by skiving, embossing or perforating the paperboard. Those skilled in the art will appreciate that weakening patterns other than longitudinal lines 44 may also result in a sufficient reduction in paperboard stiffness.

A fourth technique for reducing the stiffness of the overwrap 28 may include increasing the moisture content of the overwrap 28. For example, less (or no) sizing material (e.g., starch) may be used on the paperboard forming the overwrap 28 such that the overwrap 28 more readily absorbs moisture, such as moisture from the adhesive 26. Transfer of moisture from the adhesive 26 to the overwrap may be encouraged by using an adhesive 26 having a low water retention value.

Thus, the overwrap 28 may be sized and shaped to cover at least a portion of the base cup 24, thereby forming a multiple wall container 10 having the layered structure shown in FIG. 2. Furthermore, using an overwrap 28 having a reduced stiffness, or an overwrap 28 that loses stiffness during assembly of the multiple wall container 10, may reduce the risk of the overwrap 28 separating from the base cup 24, such as by spring-back or pealing.

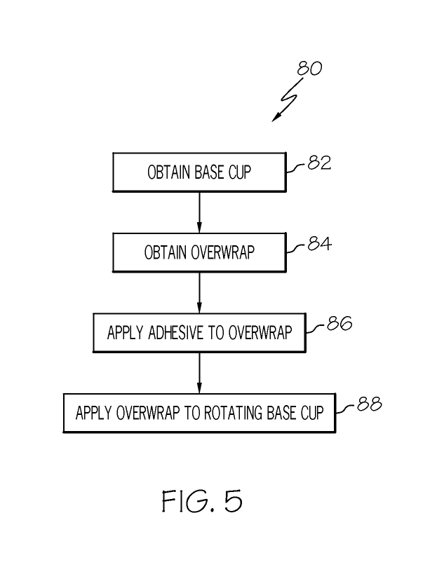

One method for assembling the disclosed multiple wall container 10 is shown in FIG. 5 and generally designated 80. As shown in blocks 82 and 84, the method 80 may begin by obtaining the base cup 24 (FIG. 3) and the overwrap 28 (FIG. 4). For example, the base cup 24 may be formed on a cup forming machine and the overwrap 28 may be die-cut from a sheet of paperboard stock.

At block 86, the adhesive 26 (FIG. 2) may be applied to the inner surface 38 (FIG. 4) of the overwrap 28 (FIG. 4). As noted above, upon application of the adhesive 26 to the overwrap 28, moisture from the adhesive 26 may be transferred to the overwrap 28, thereby reducing the stiffness of the overwrap 28.

The adhesive 26 (FIG. 2) may be applied to substantially the entire inner surface 38 (FIG. 4) of the overwrap 28 such that the annular region between the base cup 24 (FIG. 3) and the overwrap 28 is substantially entirely filled with the adhesive 26. Furthermore, the adhesive 26 may be applied to the overwrap 28 in a quantity sufficient to yield the desired cross-sectional thickness T₂ (FIG. 2) of the adhesive layer 26. Alternatively, the adhesive 26 may be applied to the overwrap 28 in various patterns, such as a string pattern or a swirl pattern.

At block 88, the adhesive-coated overwrap 28 (FIG. 4) may be applied to the base cup 24 (FIG. 3) such that the adhesive 26 (FIG. 4) connects the overwrap 28 to the base cup 24. As is described in greater detail below, the step of applying the adhesive-coated overwrap 28 to the base cup 24 may include rotating the base cup 24 about its longitudinal axis A (FIG. 3) and, as the base cup 24 rotates, transferring the adhesive-coated overwrap 28 from a vacuum transfer drum to the rotating base cup 24.

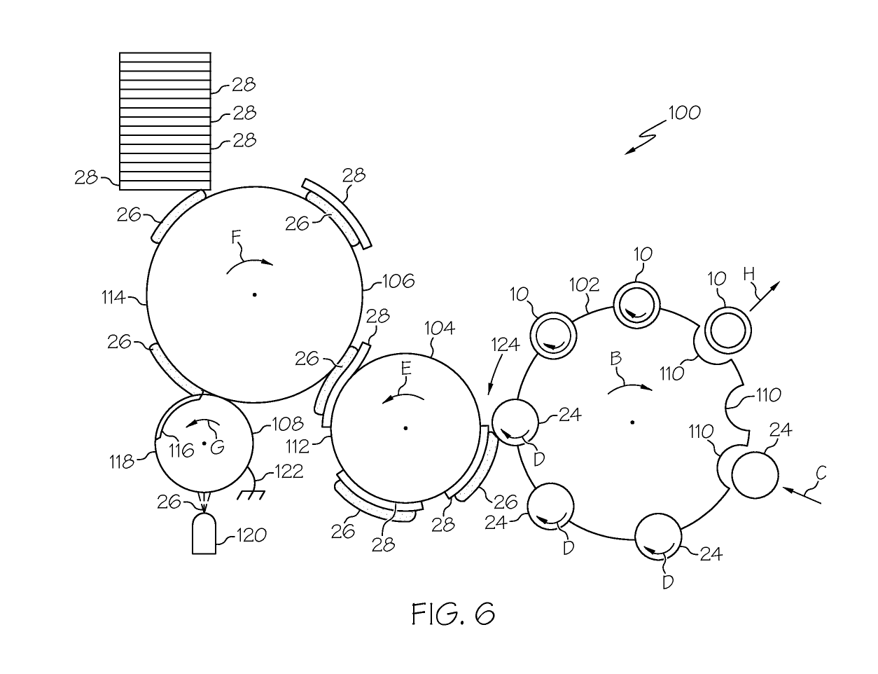

A system for forming the disclosed multiple wall container 10 is shown in FIG. 6 and generally designated 100. The system 100 may include a carousel assembly 102, a vacuum transfer drum 104, a smooth transfer drum 106 and an adhesive applicator drum 108.

The carousel assembly 102 may include a plurality of slots 110 and may rotate about an axis of rotation in the direction shown by arrow B. Each slot 110 of the carousel assembly 102 may be sized and shaped to receive a base cup 24 (see arrow C) and rotate the base cup 24 about its longitudinal axis A (FIG. 3) in the direction shown by arrow D. For example, each slot 110 may include a pair of chucks (not shown) that grasp the base cup 24 and then rotate the base cup 24 in the direction shown by arrow D.

The vacuum transfer drum 104 may rotate about an axis of rotation in the direction shown by arrow E. As the vacuum transfer drum 104 rotates, vacuum suction at the surface 112 of the vacuum transfer drum 104 may pull overwraps 28 from the smooth transfer drum 106 and may support the overwraps 28 on the surface 112 of the vacuum transfer drum 104 until the overwraps 28 are transferred to the base cups 24 of the carousel assembly 102. Vacuum suction may cease proximate the nip 124 between the vacuum transfer drum 104 and the carousel assembly 102 to facilitate transfer of the overwraps 28 from the vacuum transfer drum 104 to the base cups 24.

Thus, the vacuum transfer drum 104 may receive overwraps 28 coated with an adhesive 26 from the smooth transfer drum 106, and may transfer the adhesive-coated overwraps 26 to associated base cups 24 as the base cups 24 rotate within the slots 110 of the carousel assembly 102. After an optional drying step, the resulting multiple wall containers 10 may be removed from the carousel assembly 102, as shown by arrow H.

The smooth transfer drum 106 may rotate about an axis of rotation in the direction shown by arrow F. As the smooth transfer drum 106 rotates, the adhesive applicator drum 108 may apply an adhesive 26 directly to the surface 114 of the smooth transfer drum 106. Then, with continued rotation, an overwrap 28 may be applied to the adhesive 26 on the surface 114 of the smooth transfer drum 106. For example, surface adhesion between the adhesive 26 and the overwrap 28 may pull the overwrap 28 from a stack of overwraps 28, and may maintain engagement between the overwrap 28 and the adhesive 26 as the smooth transfer drum 106 rotates toward the vacuum transfer drum 104.

The adhesive applicator drum 108 may rotate about an axis of rotation in the direction shown by arrow G to apply the adhesive 26 to the smooth transfer drum 106. A recess 116 may be defined in the surface 118 of the adhesive applicator drum 108. An applicator 120 may apply (e.g., spray) adhesive 26 onto the surface 118 of the adhesive applicator drum 108. A blade 122 may urge the adhesive 26 into the recess 116, and may remove excess adhesive 26 from the surface 118 of the drum 108. Therefore, as the adhesive applicator drum 108 rotates relative to the smooth transfer drum 106, the adhesive 26 is transferred from the recess 116 of the adhesive applicator drum 108 to the surface 114 of the smooth transfer drum 106.

Thus, the adhesive applicator drum 108 may apply adhesive 26 to the surface 114 of the smooth transfer drum 106. As the smooth transfer drum 106 rotates, the adhesive 26 on the surface 114 thereof may engage an overwrap 28, thereby coating the overwrap 28 with the adhesive 26 and transferring the adhesive-coated overwrap 28 to the vacuum transfer drum 104. The vacuum transfer drum 104 may pull the adhesive-coated overwrap 28 from the smooth transfer drum 106 and may transfer the adhesive-coated overwrap 28 to a rotating base cup 24 supported by the carousel assembly 102.

Accordingly, the disclosed system 100 may continuously apply overwraps 28 to base cups 24 to form multiple wall containers 10. When provided with a sufficient supply of base cups 24, adhesive 26 and overwraps 28, it is believed that the disclosed system 100 may run at a production speed of 800 cups per minute or more.

Although various aspects of the multiple wall container and system and method for forming the same have been shown and described, modifications may occur to those skilled in the art upon reading the specification. The present application includes such modifications and is limited only by the scope of the claims.

What is claimed is:

1. A method for forming a multiple wall container comprising the steps of:
providing a base container and an overwrap, said base container defining a longitudinal axis;
applying an adhesive to at least a portion of said overwrap;
rotating said base container about said longitudinal axis; and
applying said adhesive-coated overwrap to said base container while said base container is rotating.

2. The method of claim 1 wherein said base container comprises a side wall and a base wall, and wherein said applying step comprises applying said adhesive-coated overwrap to said side wall of said base container.

3. The method of claim 1 wherein said adhesive-coated overwrap is applied to said base container such that said adhesive forms an adhesive layer between said base container and said overwrap, said adhesive layer having a cross-sectional thickness of at least 4 points.

4. The method of claim 1 wherein said base container comprises an inner surface, and wherein said inner surface is coated with a moisture barrier material.

5. The method of claim 1 further comprising the step of forming said base container.

6. The method of claim 5 wherein said base container is at least partially formed from a paperboard blank.

7. The method of claim 5 wherein said base container is formed on a cup/container forming machine.

8. The method of claim 1 wherein said adhesive comprises water.

9. The method of claim 1 wherein said adhesive has a pseudoplasticity index ranging from about 0.3 to about 0.5.

10. The method of claim 1 wherein said adhesive has a first thermal conductivity and said base container has a second thermal conductivity, and wherein said second thermal conductivity is greater than said first thermal conductivity.

11. The method of claim 1 wherein said step of applying said adhesive to said overwrap comprises applying said adhesive to said overwrap in a string pattern.

12. The method of claim 1 wherein said overwrap comprises paperboard.

13. The method of claim 12 wherein said paperboard has a basis weight of at least 85 pounds per 3000 square feet and a caliper thickness of at least 6 points.

14. The method of claim 12 wherein said paperboard has a basis weight of at least 180 pounds per 3000 square feet and a caliper thickness of at least 8 points.

15. The method of claim 12 wherein said paperboard has a cross direction Taber 15° stiffness of at most 100 gcm.

16. The method of claim 1 further comprising the step of mechanically weakening said overwrap.

17. The method of claim 16 wherein said step of mechanically weakening said overwrap comprises forming longitudinal score lines in said overwrap.

18. The method of claim 1 wherein said step of applying said adhesive-coated overwrap to said base container comprises transferring said adhesive-coated overwrap from a vacuum transfer drum to said rotating base container.

19. A method for forming a multiple wall container comprising the steps of:
providing a base container that defines a longitudinal axis and includes a side wall and a base wall, wherein said side wall circumferentially extends about said longitudinal axis;
providing an overwrap comprising paperboard;
applying an adhesive to said overwrap;
rotating said base container about said longitudinal axis; and
applying said overwrap to said side wall of said base container while said base container is rotating such that said adhesive is positioned between said side wall and said overwrap.

20. A system for applying an overwrap to a base container to form a multiple wall container, said system comprising:
a carousel assembly configured to rotate about a first axis of rotation, said carousel assembly supporting said base container and rotating said base container about a longitudinal axis of said base container; and
a vacuum transfer drum configured to rotate about a second axis of rotation, said vacuum transfer drum supporting said overwrap, said overwrap being at least partially coated with an adhesive,
wherein said vacuum transfer drum is positioned proximate said carousel assembly such that said vacuum transfer drum transfers said adhesive-coated overwrap to said base container as said base container is rotated by said carousel assembly.
